(19) United States
(12) Patent Application Publication
(10) Pub. No.: US 2010/0287584 A1
(43) Pub. Date: Nov. 11, 2010

(54) PARENTAL CONTROL FOR MEDIA PLAYBACK

(75) Inventors: Yuri Starikov, Redmond, WA (US); Philip Lo, Bellevue, WA (US); Jeffrey S. Stone, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/437,397

(22) Filed: May 7, 2009

(51) Int. Cl. H04N 7/16

(52) U.S. Cl. 725/28

(57) ABSTRACT

Embodiments related to the parental control of media item playback are disclosed. In one embodiment, a computing device is configured to receive an input of unified parental control information that comprises a selection of an age to which to compare a rating of a media item. The computing device is further configured to receive a first media item and a second media item that are rated under different first and second rating systems, and to receive ratings information associated with each media item. The computing device is further configured to compare the ratings information for each media item to the unified parental control information, and to restrict playback of the first and/or second media item if the unified parental control information meets a threshold condition compared to the ratings information associated with the first and/or second media item.

### BACKGROUND

Various technologies exist that allow a parent to control a child's access to media content. For example, so-called “V-chip” technology allows a parent to restrict viewing of television shows based upon television show ratings. Further, many types of media content have ratings that provide a parent with information that can be used in a decision to allow a child to purchase, view or otherwise access media content. For example, unedited movies shown on premium cable television or satellite channels generally have ratings that may be used to restrict access in a similar manner, as do video games, music, etc.

However, many types of content are rated under different rating system. For example, television shows are rated in the U.S. under the “TV Parental Guidelines” established by the National Association of Broadcasters, the National Cable Television Association and the Motion Picture Association of America, and include ratings such as TV-Y (all children), TV-Y7 (older children), TV-Y7-FV (older children, may be more intense than other TV-Y7 shows), TV-G (general audience—all ages), TV-PG (parental guidance suggested; may include sub-ratings for violence, sexual situations, strong language, and suggestive dialogue), TV-14 (may be unsuitable for children under 14), and TV-MA (may be unsuitable for children under 17).

On the other hand, movie ratings established by the Motion Picture Association of America and the National Association of Theater Owners utilize ratings such as G (general audience—all ages), PG (some material may not be suitable for children), PG-13 (some material may be inappropriate for children under 13, R (under 17 requires accompanying parent or adult guardian), and NC-17 (no one 17 or under admitted). Video games and music are each rated under their own rating schemes.

Further, other countries may utilize yet other rating systems for each of these content types. As content from around the world becomes more and more accessible via the Internet (for example, via Internet television), parents in one country may increasingly encounter media items with ratings from other countries.

### SUMMARY

Accordingly, various embodiments are disclosed that are related to facilitating parental control of access to various types of media content. For example, in one disclosed embodiment, a computing device is configures to receive an input of a unified parental control information that comprises an age to which to compare a rating of a media item. The computing device is further configured to receive a first media item that is rated under a first rating system, to receive ratings information associated with the first media item, to compare the ratings information associated with the first media item to the unified parental control information, and to restrict playback of the first media item if the unified parental control information meets a threshold condition compared to the ratings information associated with the first media item. The computing device is further configured to receive a second media item that is rated under a second rating system that is different than the first rating system, to receive ratings information associated with the second media item, to compare the ratings information associated with the second media item to the unified parental control information, and to restrict playback of the second media item if the unified parental control information meets a threshold condition compared to the ratings information associated with the second media item.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a media content distribution and consumption environment.

FIG. 2 shows an embodiment of a method for controlling playback of a media item.

FIG. 3 shows another embodiment of a method for controlling playback of a media item.

FIG. 4 shows a block diagram of an embodiment of a system for controlling playback of a media item, and also illustrates data flow through the system.

### DETAILED DESCRIPTION

As mentioned above, media content may be rated under any of a number of different rating systems, depending upon the type of content and the geographic location (e.g. country) in which the media item is intended for consumption. Current media playback devices are often capable of receiving and playing back many different types of media content from many sources. For example, a media player on a computing device may be configured to receive and play back movies, music, television shows, images, etc., received from sources such as local removable media drives, network connections, broadcast receivers, etc. In light of this versatility, the parental control settings used to control the playback of such media items may become more difficult to manage.

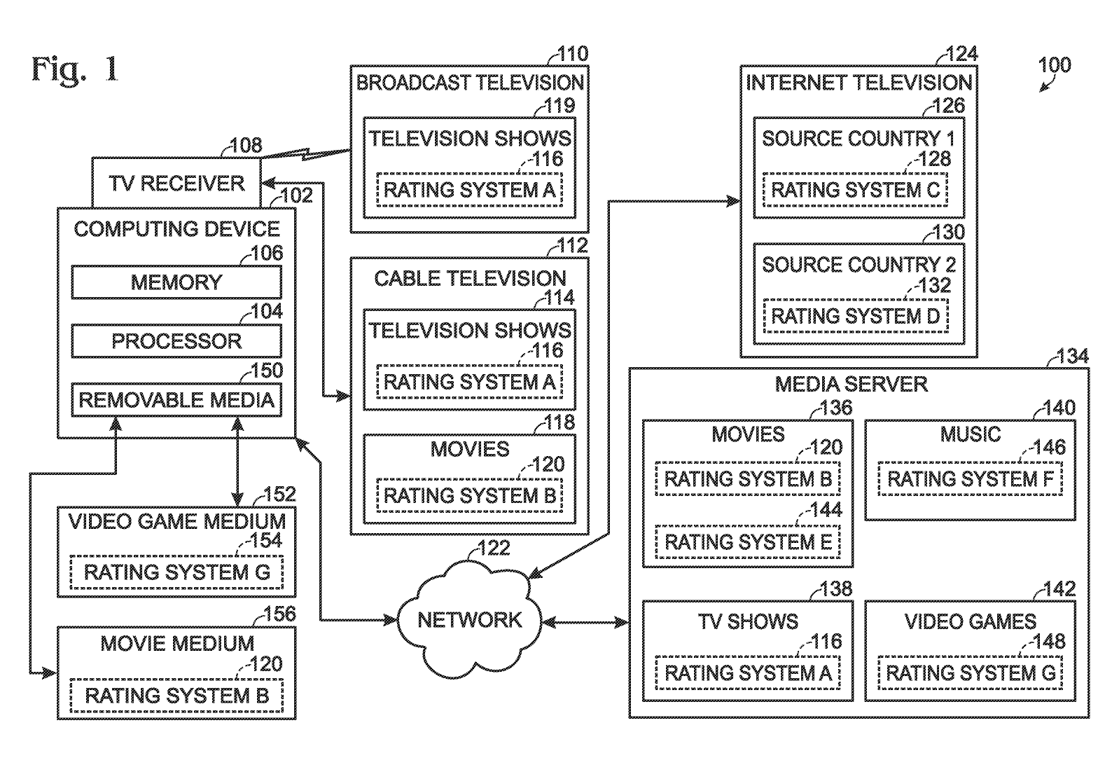

Therefore, embodiments are disclosed herein that facilitate the setting and management of parental control settings in light of such diversity in media content type and source. Prior to discussing these embodiments in detail, an example use environment 100 is described with reference to FIG. 1. Use environment 100 comprises a computing device 102 configured to receive media content from a variety of sources and to play the media content back to a user via a monitor, television display, or the like (not shown). The computing device 102 comprises a processor 104, and memory 106 with instructions stored thereon that are executable by the processor 104 to perform various tasks related to the receipt and playback of media items, including but not limited to various methods of playback control disclosed herein.

The computing device 102 further comprises a television receiver 108. The television receiver 108 may be incorporated into the computing device, or may be external to the computing device, and may be configured to receive television from a broadcast source 110, from a cable source 112, and/or any other suitable source, including but not limited to a satellite source (not shown).

As shown in FIG. 1, television shows 114 received from broadcast source 110 and cable source 112 may be rated under a rating system used specifically for television shows, such as the above-described TV Parental Guidelines that are used in the U.S. In FIG. 1, rating systems are referred to with arbitrary letters to distinguish different rating systems. Therefore, as indicated in FIG. 1, television shows 114 originating from the broadcast source 110 and cable source 112 are each rated via a first rating system, shown as “rating system A” 116. Further, movies 118, such as unedited feature films, may be provided via the cable source 112 (as well as via other television sources). Such movies 118 may be rated by a second rating system, indicated as “rating system B” 120, that is different from rating system A used for television shows.

Computing device 102 also may be configured to receive media items over a network 122, such as the Internet. For example, computing device 102 may be configured to receive internet television shows from one or more internet television sources 124. Further, internet television sources 124 may be located in different countries, and therefore may provide television shows rated under different rating systems. This is indicated in FIG. 1 as internet television content from “source country 1” 126 that is rated under “rating system C” 128, and internet television content from “source country 2” 130 that is rated under “rating system D” 132.

Computing device 102 may also receive media over network 122 from a media server 134. Such a media server 134 may be configured to provide various types of media items, including but not limited to movies 136, pre-recorded and/or live television shows 138, music 140, video games 142, etc. Each of these types of media items may be rated under one or more rating systems. For example, as depicted in FIG. 1, a movie may be rated under two separate rating systems, shown as the previously mentioned rating system B 120 and also rating system E 144. As a specific example, a movie that was originally filmed in the U.S. and then translated into French for a French audience may contain ratings both for U.S. audiences and for French viewers. Such a movie also may contain a third set of ratings for a French Canadian viewer, for example. Further, the media server may contain television shows rated under the previously mentioned rating system A 116 (or any other suitable rating system), as well as music rated under a rating system F 146, and video games rated under a rating system G 148.

The computing device also may include a removable media drive 150 configured to receive a removable medium, such as a digital versatile disk (DVD), a compact disk (CD), a flash memory drive, etc. In FIG. 1, removable media drive 150 is depicted as receiving media content from a video game medium 152, such as a video game stored on a DVD, that comprises a video game a rating made under rating system G 154. Further, removable media drive 150 is also depicted as receiving media content from a movie medium 156, such as a movie stored on a DVD, that is rated under rating system B 120.

It will be understood that the embodiment of FIG. 1 is shown to illustrate a potential breadth of rating systems and media content sources that may be encountered when accessing media content via the computing device 102, and is not intended to be limiting in any manner, as a computing device may be configured to receive any suitable media content, whether rated or unrated, from any suitable media source, without departing from the scope of the present disclosure.

Due at least in part to various rating systems being promulgated by different organizations that attempt to address different potential parental concerns, and that are potentially located in different countries, the various rating systems that the computing device 102 may encounter during ordinary use may use different rating conventions (e.g. age-based, letter-based, etc.), that have different numbers of ratings levels (e.g. U.S. television ratings include seven different ratings, while U.S. movie ratings include five different ratings), and that change between ratings levels at different specified ages. For example, the U.S. television rating TV-14 specifies an age of 14 years of age as a threshold age, while the U.S. movie rating PG-13 specifies an age of 13 years as a threshold age.

From the standpoint of parental control settings, a parent setting up and/or managing such a large number of potential ratings via a parental access control program currently may be prompted to select a desired rating for each different rating system supported by the computing device. This may further involve selecting desired ratings for rating systems from different countries, as a child may access media content from other countries via a network connection, satellite television, or the like. Further, when a child grows older, or when a younger child starts to seek out media content, changing such a large number of settings may be a relatively lengthy process, and may be subject to error if a parent forgets to change one or more of the ratings.

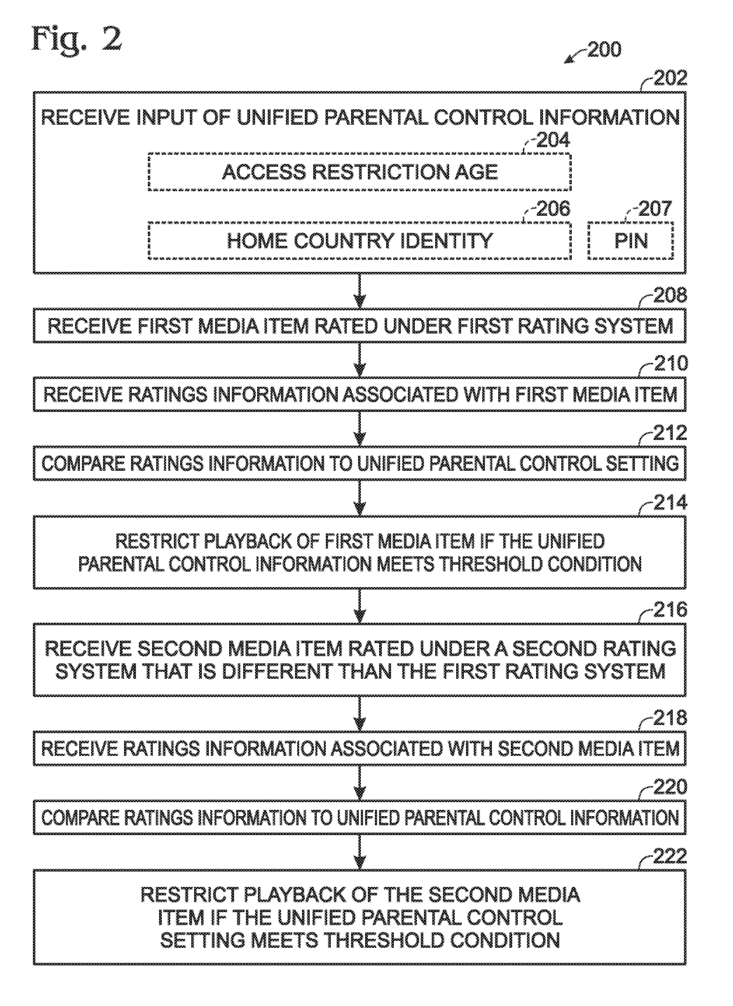

Therefore, FIG. 2 shows a method 200 for controlling playback of media items that facilitates the setting and management of parental access control settings in such a media environment. Method 200 comprises, at 202, receiving an input of unified parental control information. The term “unified parental control information” as used herein comprises, among other potential information, a single age-based value that is used to determine whether to restrict content rated under any rating system, or even under no rating system. In this manner, a parent can avoid having to pick a specific rating under each possible rating system at which to restrict access when setting or modifying access control settings.

In the depicted embodiment, the unified parental control information comprises an access restriction age 204 and a home country identity 206. The access restriction age 204 specifies an age that a parent or other user wishes to have compared to media content ratings to determine whether to restrict playback of a media item. For example, a parent may enter the actual age of a child as the access restriction age, may enter an age older than the child if the child is perceived to be relatively more mature, or may enter an age younger than the child if stricter control is desired. The home country identity 206 allows the determination of a correct rating to utilize where a media item contains ratings from more than one rating system. It will be understood that the unified parental control information may also include additional information, such as a personal identification number (PIN) 207 that can be entered to allow a restricted media item to be unlocked for playback, additional access control information (e.g. special rules to apply where content is rated as containing violence, sexual situations, etc.), and other attributes of the media item. In some embodiments, the parental control information may support up to 2̂32 different attributes.

Continuing with FIG. 2, method 200 next comprises, at 208, receiving a first media item rated under a first rating system, and, at 210, receiving from the first media item any ratings information associated with the first media item. The ratings information may comprise a rating of the media item under one or more rating systems, as well as rating attributes (violence, sexual content, strong language, etc.) that provide further information on the rating.

Next, the ratings information is compared to the unified parental control information at 212 to determine if playback of the media item is to be restricted. Comparing the ratings information to the unified parental control information may involve various processes. For example, a rating contained within the ratings information may be converted to an age value for comparison to the access restriction age 204 in the unified parental control information. The term “converted to an age value” and the like signify any conversion of a rating of any type to an age value that can be compared to the access restriction age 204. For example, under the U.S. movie rating system, the letter rating “R” may be converted to an age value of 17 for comparison to the access control age. Likewise, the alphanumeric rating PG-13 may be converted to an age value of 13 for comparison to the access control age.

Next, if it is determined that the unified parental control information meets a threshold condition compared to the ratings information, then, at 214, playback of the first media item is restricted. For example, if it is determined that the access restriction age 204 in the unified parental control information 202 is less than the age value to which the first media item rating was converted, playback may be restricted.

Continuing with FIG. 2, method 200 next comprises, at 216, receiving a second media item that is rated under a second rating system that is different than the first rating system. For example, where the first media item is a movie rated under the U.S. motion picture rating system (MPAA), the second media item may be a television show, a video game, a song, a media item rated under the rating system of another country, or any other suitable media item. Upon receipt of the second media item, method 200 next comprises, at 218, receiving ratings information from the second media item, and then, at 220, comparing the ratings information received from the second media item to the unified parental control information. As mentioned above, in some embodiments, this comparison may comprise converting a rating within the ratings information received from the second media item to an age-based value, and then comparing the age-based value to the access restriction age 204 contained within the unified parental control information 202. If it is determined that the ratings information meets a threshold condition relative to the unified parental control information, then playback of the second media item is restricted.

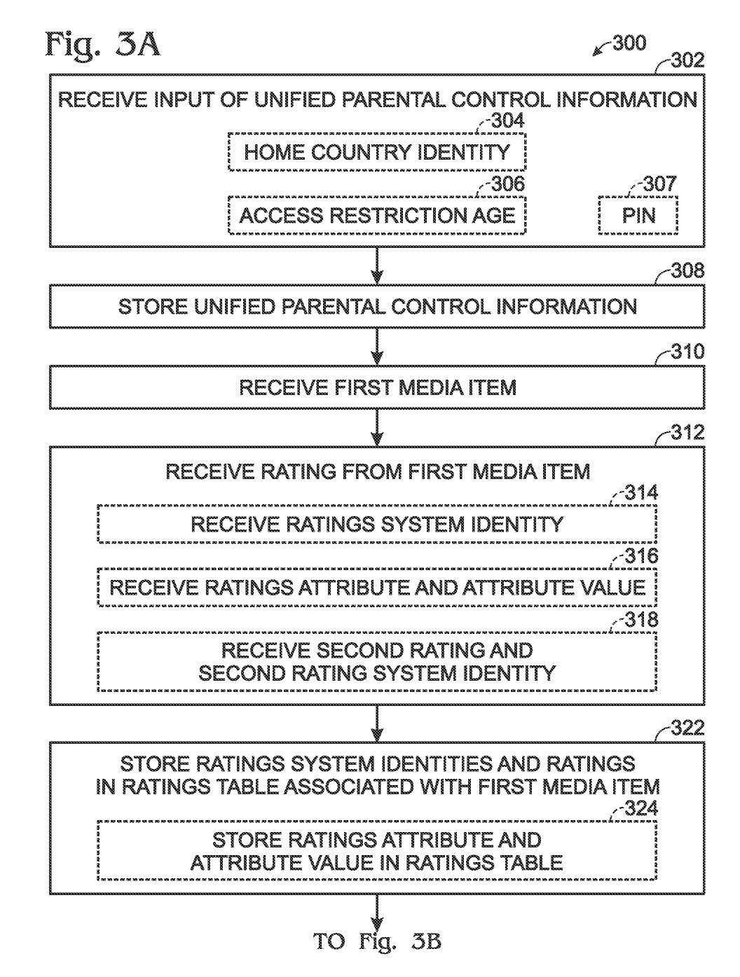

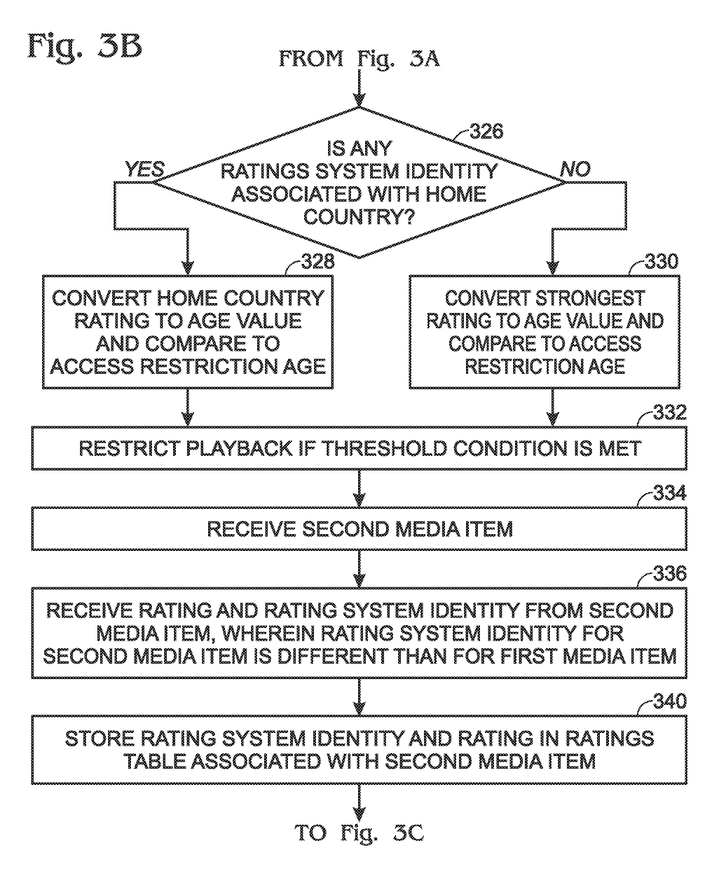

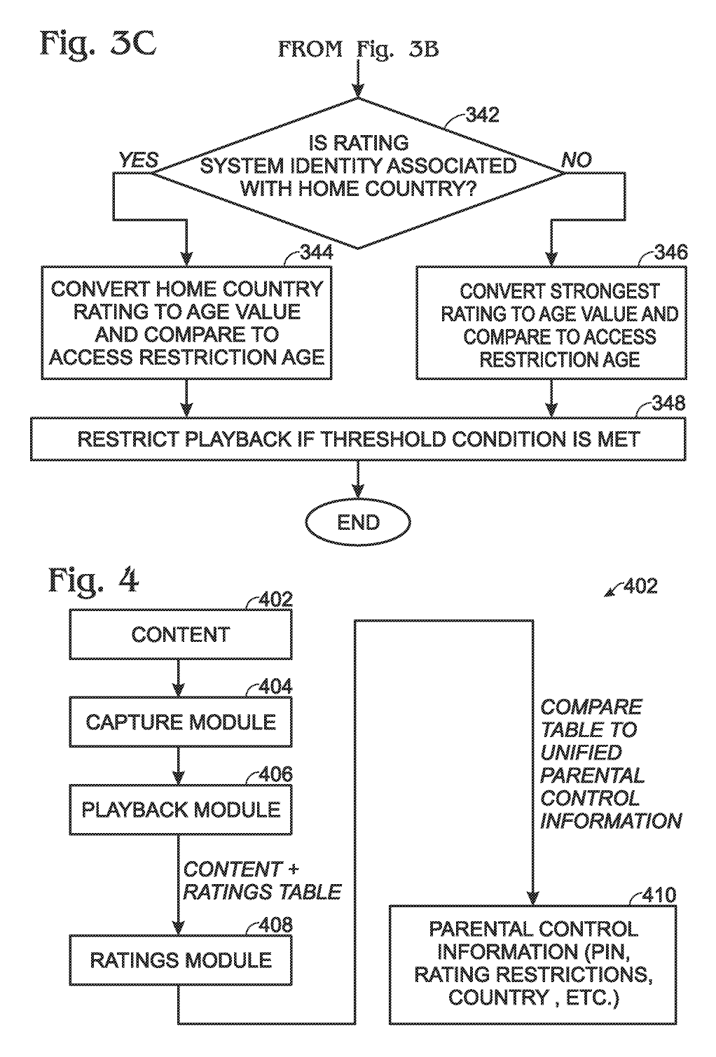

FIG. 3 shows a flow diagram of a more detailed embodiment of a method 300 of controlling playback of a media item. As described above for method 200, method 300 comprises, at 302, receiving an input of unified parental control information, which may include a home country identity 304, an access restriction age 306, a PIN 307, as well as any other suitable information. A parent may enter this information, for example, at a central parental control user interface, or in any other suitable manner. It will be understood that, in some embodiments, a parent also may choose an access restriction age by selecting a desired rating in one rating system. In this case, the entered rating may be converted to an access restriction age value for comparison to other ratings. Upon receipt of this input, method 300 comprises, at 308, storing the unified parental control information.

Next, method 300 comprises, at 310, receiving a first media item, and, at 312, receiving a rating from the first media item. Other ratings information may be received in addition to the rating. For example, a rating system identity may be received, as indicated at 314, to allow the rating to be converted to an age value, as well as to allow the determination of whether the rating is from a home country rating system. Further, one or more rating attributes may be received, as indicated at 316. A rating attribute may comprise, for example, a subrating such as a “violence”, “language”, “sexual content”, “suggestive dialogue”, “fantasy violence”, or other subrating. Further, a rating attribute may comprise a time range during which parental controls will apply. Such an attribute may be used in countries in which time-dependent access restriction rules exist. For example, some European countries may impose regulations whereby a content item may be unconditionally restricted (i.e. restricted no matter the ratings) during select times of the day such that it is viewable only by entering a PIN, but restricted according to the user's parental control information during other times of the day. In this case, the rating attribute may comprise an indication of this restriction. A rating attribute value comprising a window of time during the day in which such stronger restriction applies also may be received with the rating attribute.

Continuing with FIG. 3, receiving the rating at 312 also may comprise, at 318, receiving a second rating and second rating system identity. As described above, this may occur, for example, where a movie is originally produced for viewing in one country and is later translated for viewing in another. It will be understood that, in some cases, a media item may have three or more ratings encoded into the media item.

Next, at 322, the ratings and rating system identities are stored in a ratings table associated with the first media item. The term “associated with the first media item” as used herein signifies that the ratings table and first media item are linked such that the ratings table may be located and accessed by a device playing the media item. In some specific embodiments, the ratings table may be appended to the first media item such that the ratings table and first media item are stored as a single file, while in other embodiments, the ratings table and first media item may be stored separately. Further, as indicated at 324, any ratings attributes and associated attribute values received at 316 are also stored in the ratings table.

After receiving and storing the ratings, rating system identities, and any ratings attributes, it is determined at 326 if any rating system for any of the stored ratings is associated with the home country identity. If the answer to this inquiry is yes, then, at 328, the home country rating is converted to an age value, which is then compared to the access restriction age. Next, at 330, playback is restricted if a threshold condition is met (e.g. if the access restriction age is lower than the rating age value). On the other hand, if it is determined at 326 that none of the stored rating system identities are associated with the home country identity, then, at 330, a strongest rating in the ratings information is converted to an age value, and compared to the access control age. Then, playback is restricted at 332 if the age value meets a threshold condition relative to the access control age.

Continuing with FIG. 3, method 300 next comprises, at 334, receiving a second media item, and then, at 336, receiving a rating and rating system identity from the second media item, wherein the second rating system identity is different from the first rating system identity. Next, the second rating is stored, at 338, along with the rating system identity in a ratings table associated with the second media item. Next, at 342, it is determined if the rating system identity stored in the ratings table associated with the second media item is associated with the home country. If so, then method 300 comprises, at 344, converting the home country rating to an age value, and comparing this age value to the access restriction age. If the age value meets a threshold condition relative to the access control age, then, at 348, playback is restricted.

On the other hand, if the rating system is determined at 342 not to be associated with the home country, then a strongest rating is converted to an age value, and the age value is compared to the access restriction age to determine whether to restrict playback at 348. Again, if a threshold condition is met, playback may be restricted. It will be understood that playback may still be allowed, even where restricted, if a viewer enters a PIN to unlock the restricted media item.

It will be understood that some media items may contain no ratings information. Therefore, in some embodiments, a parent may able to select whether or not to restrict playback of any unrated media items. This option may be selected, for example, as a part of the unified parental control information that is input by a parent.

FIG. 4 shows a block diagram of a logical architecture for a system 400 for controlling playback of media items. A media item 402 first enters system 400 at a capture module 404. Capture module 404 is configured to receive ratings information from the content and to store the rating information in a ratings table. Where multiple ratings are contained within a media item, the multiple ratings may be stored in a single ratings table, or in separate ratings tables. Further, the ratings information may include other information, such as sub-ratings, time segments in which a media item is subject to additional restrictions, and information regarding whether a PIN is required for the viewing of content.

After the capture component receives the ratings information and stores the ratings information in the ratings table, the media item may be accessed by a playback module 406 that controls the playback of the media item. The playback module is further configured to call a ratings module 406 that is configured to convert ratings, subratings, etc. stored in the ratings information to age values. The ratings module is also configured to compare the age values, rating system identity, and other information, to the unified parental control information which are then compared against the user's settings for the user's home country. If it is determined that playback is to be restricted, then the ratings module directs the playback module to restrict playback. In this case, playback may be enabled (e.g. unlocked) by entering a PIN.

In this manner, a single age-based value input by a parent may be used to control access to multiple different types of content rated under multiple different ratings systems. Further, a home country identity input may allow a correct rating for a media item to be selected where the media item has ratings from more than one country. This may facilitate the setting and management of parental control settings compared to the management of each different rating system separately. It will be understood that the configurations and/or approaches described herein for restricting playback of media items are presented for the purpose of example and not intended to be limiting, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and non-obvious combinations and subcombinations of the various processes, systems and configurations, and other features, functions, acts, and/or properties disclosed herein, as well as any and all equivalents thereof.

1. A computing device, comprising:
a processor; and
memory comprising instructions executable by the processor to:
receive an input of unified parental control information that comprises an access restriction age to which to compare to a rating of a media item;
receive a first media item that is rated under a first rating system;
receive ratings information associated with the first media item;
compare the ratings information associated with the first media item to the unified parental control information;
restrict playback of the first media item if the unified parental control information meets a threshold condition compared to the ratings information associated with the first media item;
receive a second media item that is rated under a second rating system that is different than the first rating system;
receive ratings information associated with the second media item;
compare the ratings information associated with the second media item to the unified parental control information; and
restrict playback of the second media item if the unified parental control information meets a threshold condition compared to the ratings information associated with the second media item.

2. The computing device of claim 1, wherein the ratings information comprises a rating, and wherein the instructions are executable to compare the ratings information associated with the first media item to the unified parental control information by converting the rating to an age value and comparing the age value to the access restriction age.

3. The computing device of claim 2, wherein the instructions are executable to receive a home country identity as a part of the unified parental control information.

4. The computing device of claim 3, wherein the ratings information comprises a rating system identity, and wherein the instructions are further executable to receive the rating system identity and determine if the rating system identity is associated with a home country rating system.

5. The computing device of claim 4, wherein the instructions are further executable to compare the age value to the access control age only if the rating system identity is associated with the home country.

6. The computing device of claim 4, wherein the instructions are executable to convert a strongest rating in the ratings information to an age value, and to compare the age value to the access control age if the rating system identity is not associated with the home country.

7. The computing device of claim 4, wherein the ratings information for the first media item comprises ratings under two or more rating systems.

8. The computing device of claim 1, wherein the first rating system and second rating system each comprises one of a television rating system, a movie rating system, a music rating system, and a video game rating system.

9. The computing device of claim 1, wherein the first rating system is used in a first country, and wherein the second rating system is used in a second country.

10. A method of controlling playback of a media item, comprising;
receiving an input of unified parental control information, the unified parental control information comprising a home country identity and an access restriction age;
storing the unified parental control information;
receiving a media item;
receiving a rating for the media item;
converting the rating to an age value;
comparing the age value to the access restriction age; and
restricting playback of the media item if a threshold condition of the age value relative to the access restriction age is met.

11. The method of claim 10, wherein receiving a rating from the media item comprises receiving a rating system identity along.

12. The method of claim 11, further comprising determining whether the rating system is a home country rating system by comparing the rating system identity to the home country identity, and comparing the age value to the access restriction age only if the rating is from the home country rating system.

13. The method of claim 12, further comprising comparing the access restriction age to a strongest rating of the plurality of ratings if the rating is not from the home country rating system.

14. The method of claim 10, further comprising storing the rating and the rating system identity in a ratings table, and storing the ratings table with the media item prior to converting the rating to the age value for comparison to the access restriction age.

15. The method of claim 14, further comprising receiving a rating attribute from the media data, and storing the rating attribute in the ratings table.

16. The method of claim 15, wherein the rating attribute comprises a subrating.

17. The method of claim 15, wherein the rating attribute comprises a window of time during which a stronger restriction applies.

18. The method of claim 14, wherein the rating is a first rating, wherein the rating system identity is a first rating system identity, and further comprising:
receiving a second rating and a second rating system identity from the media item;
storing the second rating and the second rating identity in the ratings table; and
determining which rating to compare to the unified parental control information by comparing the first rating system identity and the second rating system identity to the home country information to determine whether either rating system is a home country rating system.

19. A computer-readable medium comprising instructions stored thereon that are executable by a computing device to control playback of a media item by the computing device, wherein the instructions comprise:
instructions executable to operate a capture module, wherein the capture module is configured to:
receive an input of a media item;
receive a plurality of rating system identities and a plurality of associated ratings from the media item; and
store each rating system identity and rating in a ratings table associated with the media item;
instructions executable to operate a ratings manager module configured to:
receive an input of unified parental control information that comprises a home country identity and an access control age;
receive the ratings table associated with the media item;
compare the home country identity to the rating system identities to select a selected rating to apply;
convert the selected rating to an age value; and
compare the age value to the access control age to determine whether to restrict playback of the media item; and
instructions executable to operate a playback module configured to:
receive the media item with the ratings table;
send the ratings table to the ratings manager module; and
play the media item only if the ratings manager module does not restrict playback.

20. The computer-readable medium of claim 19, wherein the instructions are executable to compare a strongest rating of the plurality of associated ratings to compare to the access control age if none of the plurality of rating systems is associated with the home country identity.
